(19) United States
(12) Patent Application Publication
(10) Pub. No.: US 2009/0092798 A1
(43) Pub. Date: Apr. 9, 2009

(54) Plate-Shaped Material

(75) Inventor: Wilhelmus Jan Reinier Karel Snel, Zwaag (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UNDA MARIS HOLDING N.V., Curacao (AN)

(21) Appl. No.: 12/297,883

(22) PCT Filed: Apr. 13, 2007
(86) PCT No.: PCT/NL2007/050152

§ 371 Date: Oct. 21, 2008

(30) Foreign Application Priority Data
Apr. 21, 2006 (NL) 2000060

(51) Int. Cl. B32B 3/28; B32B 3/00

(52) U.S. Cl. 428/182; 428/174

(57) ABSTRACT

A plate-shaped material at least substantially made of a metal, characterised in that a corrugated (in cross-section) profile has been formed in the plane of the plate-shaped material, with the corrugations of said profile extending in meander-like fashion in the plane of the plate-shaped material, said corrugations in particular extending in zigzag or serpentine, preferably sinu-soidal fashion in the plane of the plate-shaped material.

The invention relates to a plate-shaped material at least substantially made of a metal.

Such a plate-shaped material is known from Japanese patent publication No. 7-279305. The metal plate-shaped material described therein functions as a base material which is laminated with a thermoplastic film on both sides, whilst the whole is undulated to form a corrugated core. Metal plates, such as steel or aluminium plates, are attached to both surfaces of the core through thermal fusion of the thermoplastic films. In this way a sandwich construction is realised.

The object of the invention is to improve the plate-shaped material that is known from the aforesaid Japanese patent publication, in the sense that a plate-shaped material is provided which exhibits an optimum constructional stiffness for use as a construction element in a building, for example a (part of a) facade panel or as a (part of a) wall panel, for example a partition wall or a caravan wall etc, and which at the same time is light in weight. It is, incidentally, noted in this regard that the term wall panel is understood to include an element for use in a wall, a floor, a ceiling, a roof etc.

In order to achieve that object, a plate-shaped material of the kind mentioned in the introduction is according to the invention characterised in that a corrugated (in cross-section) profile has been formed in the plane of the plate-shaped material, with the corrugations of said profile extending in meander-like fashion in the plane of the plate-shaped material. It is noted that the within the context of the invention the term “meander-like” is understood to include any shape that winds from one side to another (from the left to the right) and back. Preferably, the corrugations extend in zigzag fashion in the plane of the plate-shaped material, so that corrugations are obtained which alternately make a more or less sharp turn to the left and to the right. In another preferred variant, the corrugations extend in serpentine fashion in the plane of the plate-shaped material. Research has shown that the present construction results in an unexpectedly great constructional stiffness of the plate-shaped material, so that the plate-shaped material can be loaded with large forces without losing any of its shape stability. At the same time a surprisingly lightweight construction is obtained, which makes the construction easier to handle. Preferably, the corrugations extend parallel to each other in the plane of the plate-shaped material rather than converge or diverge with respect to each other. The profile is in particular provided along at least substantially the entire length of the plate-shaped material.

In a preferred embodiment of a plate-shaped material according to the invention, the corrugations extend in sinusoidal fashion in the plane of the plate-shaped material. The spacing between two adjacent crests of the sine shape preferably ranges between 0.25 and 2 times the amplitude of the sine shape. The spacing between two adjacent crests of the sine shape is in particular at least substantially equal to the amplitude of the sine shape. Tests have shown that in this way a construction exhibiting an optimum constructional stiffness is obtained, which is at the same time light in weight.

In another preferred embodiment of a plate-shaped material according to the invention, the plate-shaped material is made of a metal selected from the group consisting of iron, steel, copper and aluminium as well as an alloy of one or more of said metals. Preferably, the profile has been rolled into the material, as will be explained in more detail yet hereinafter.

In another preferred embodiment of a panel according to the invention, stiffening layers have been affixed to either side of the plate-shaped material by means of an adhesive. The invention thus provides a sandwich construction in which the profiled, metal plate material is bonded to a, preferably less elastic, stiffening layer on both flat outer sides thereof. This results in an even greater constructional stiffness exhibiting a correspondingly high shape stability. The adhesive is preferably an expanding glue, in particular a foaming glue, more in particular a polyurethane-based foaming glue.

In another preferred embodiment of a panel according to the invention, the (preferably) flat stiffening layers are at least substantially made of material selected from the group consisting of fibre material, plastic, rubber, metal, paper/cardboard and wood. In other words, the present profiled metal plate material is bonded on both flat (outer) sides thereof to a less elastic stiffening layer made of one of the aforesaid materials. The constructional stiffness is increased even further by using a stiffening layer having an elasticity modulus higher than or equal to 50 GPa, in particular higher than or equal to 100 GPa, more in particular higher than or equal to 150 GPa, more in particular higher than or equal to 200 GPa, more in particular higher than or equal to 300 GPa, more in particular higher than or equal to 400 GPa.

The fibre material in particular comprises glass fibres, carbon fibres, mineral fibres and/or synthetic fibres. Said synthetic fibres may for example be fibres of a type as known by the brand name “Kevlar” or “Twaron”.

The plastic layer is preferably selected from the group consisting of PVC-U, PP, PE, ABS, PVC-C and PVDF. It is noted that the above material designations relate to the following (plastic) materials:

| | |
|---|---|
| PVC-U | Polyvinyl chloride (without plasticizer) |
| PP | Polypropylene |
| PE | Polyethylene |
| ABS | Acrylonitrile-Butadiene-Styrene |
| PVC-C | Polyvinyl chloride (rechlorinated) |
| PVDF | Polyvinylidene fluoride |

The rubber layer is in particular selected from the group consisting of EPDM or NBR. In another preferred variant, the stiffening layer is made of a metal, in particular stainless steel, or wood, for example two-ply or three-ply wood.

In another preferred embodiment of a panel according to the invention, the stiffening layers or at least substantially made of layers of paper/cardboard, each layer at least substantially being made up of a corrugated sublayer and a flat sublayer affixed to one side thereof, wherein the paper/cardboard layers are interconnected via an adhesive applied to the corrugations of the corrugated sublayer. It is noted that the term “paper” is generally used for lighter paper types, whereas the term “cardboard” is often used for heavier qualities. No limitation as regards the type of material is intended within the context of the present invention when using the words paper, cardboard and quality.

The stiffening layers are preferably impregnated, in particular with a resinous material such as polyurethane or polyester resin. It is noted that impregnation with, for example, a resinous material not only has the advantage of increasing the constructional strength but also of providing protection against external influences, such as moisture. Because of the additional strength, fewer layers of corrugated paper/cardboard are in principle required for giving the flat wall panel the required stiffness. Impregnation preferably takes place by vapour deposition, spraying or otherwise, said vapour deposition or spraying taking place in a direction parallel to the direction of the “cell structure” of the corrugated paper/cardboard that is used. Impregnation can also take place by mechanical means, wherein toothed and/or flat rollers are used for pressing the impregnation agent into the paper/cardboard.

As already said before, the invention also relates to a method for manufacturing a plate-shaped material at least substantially made of a metal according to the invention, which method is characterised in that a corrugated (in cross-section) profile is formed in the plane of the plate-shaped material by means of a rolling operation, with the corrugations of the profile extending in meander-like fashion in the plane of the plate-shaped material. A non-profiled metal plate-shaped material is to that end supplied to a feed opening between two profiled rollers rotating in opposite directions, whereupon the profile is formed in the metal plate-shaped material by means of a rolling technique.

The invention will now be explained in more detail with reference to figures of a preferred variant of the invention illustrated in a drawing, in which:

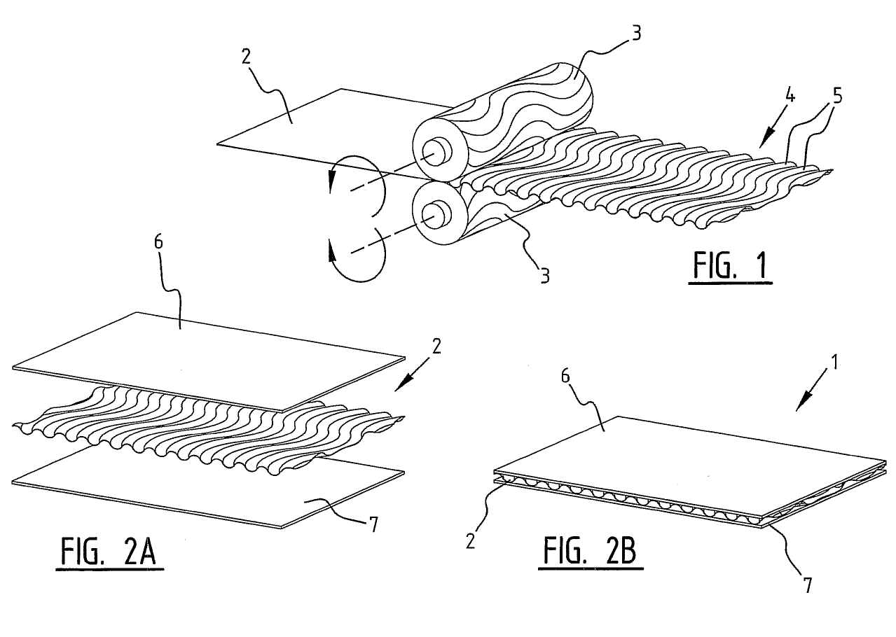

FIG. 1 is a schematic, perspective view of the present plate-shaped material; and

FIG. 2 shows the use of the plate-shaped material of FIG. 1 in a sandwich construction for a wall panel.

To manufacture a sandwich construction as shown in FIG. 2, a strip of plate material 2 made of a metal, such as aluminium, is first supplied to a feed opening between two rollers 3. As shown, the strip of plate material as starting material is non-profiled (flat). By rotating the rollers 3 in opposite directions, a profile 4 is formed in the plane of the aluminium strip 2 along the entire length thereof. As shown in the drawing, the profile 4 is corrugated in cross-section and consists of mutually parallel corrugations 5 extending in sinusoidal fashion in the plane of the aluminium strip 2. To obtain an optimum constructional stiffness, the spacing d between two adjacent crests of the sign shape is at least substantially equal to the amplitude a of the sine shape.

Referring now to FIG. 2, less elastic, flat outer layers 6, 7 of a plastic material, for example PVC, are glued to either side of the profiled aluminium plate material 2 of FIG. 1. Use is made of a foaming polyurethane adhesive for this purpose. In this way a sandwich construction 1 is realised for use as a wall panel, for example in a caravan.

It is noted that the invention is not limited to the embodiment shown in the figures, but that it also extends to other variants that fall within the scope of the appended claims. Thus it will be apparent to those skilled in the art that the wall panel may exhibit a (slight) curvature.

1. A plate-shaped material at least substantially made of a metal, characterised in that a corrugated (in cross-section) profile has been formed in the plane of the plate-shaped material, with the corrugations of said profile extending in meander-like fashion in the plane of the plate-shaped material.

2. A plate-shaped material according to claim 1, wherein the corrugations extend parallel to each other in the plane of the plate-shaped material.

3. A plate-shaped material according to claim 1, wherein the corrugations extend in zigzag fashion in the plane of the plate-shaped material.

4. A plate-shaped material according to claim 1, wherein the corrugations extend in serpentine fashion in the plane of the plate-shaped material.

5. A plate-shaped material according to claim 4, wherein the corrugations extend in sinusoidal fashion in the plane of the plate-shaped material.

6. A plate-shaped material according to claim 5, wherein the spacing between two adjacent crests of the sine shape ranges between 0.25 and 2 times the amplitude of the sine shape.

7. A plate-shaped material according to claim 6, wherein the spacing between two adjacent crests of the sine shape is at least substantially equal to the amplitude of the sine shape.

8. A plate-shaped material according to claim 1, wherein the profile has been formed along at least substantially the entire length of the plate-shaped material.

9. A plate-shaped material according to claim 1, wherein the plate-shaped material is made of a metal selected from the group consisting of iron, steel, copper and aluminium as well as an alloy of one or more of said metals.

10. A plate-shaped material according to claim 1, wherein stiffening layers have been affixed to either side of the plate-shaped material by means of an adhesive.

11. A plate-shaped material according to claim 10, wherein the stiffening layers are at least substantially made of material selected from the group consisting of fibre material, plastic, rubber, metal, paper/cardboard and wood.

12. A plate-shaped material according to claim 11, wherein the fibre material comprises glass fibres, carbon fibres, mineral fibres and/or synthetic fibres .

13. A plate-shaped material according to claim 11, wherein the stiffening layers are at least substantially made of layers of paper/cardboard, each layer at least substantially being made up of a corrugated sublayer and a flat sublayer affixed to one side thereof, wherein the paper/cardboard layers are interconnected via an adhesive applied to the corrugations of the corrugated sublayer.

14. A plate-shaped material according to claim 13, wherein the stiffening layers are impregnated, in particular with a resinous material.

15. A plate-shaped material according to claim 11, wherein the stiffening layers are at least substantially made of two-ply or three-ply wood.

16. A method for manufacturing a plate-shaped material at least substantially made of a metal according to any claim 1, characterised in that a corrugated (in cross-section) profile is formed in the plane of the plate-shaped material by means of a rolling operation, with the corrugations of the profile extending in meander-like fashion in the plane of the plate-shaped material.

17. A plate-shaped material according to claim 2, wherein the corrugations extend in zigzag fashion in the plane of the plate-shaped material.

18. A plate-shaped material according to claim 2, wherein the corrugations extend in serpentine fashion in the plane of the plate-shaped material.
